(19) United States
(12) Patent Application Publication
(10) Pub. No.: US 2010/0125394 A1
(43) Pub. Date: May 20, 2010

(54) Vehicle With A Loader

(76) Inventor: Sébastien Portet, Chargey les Gray (FR)

Correspondence Address: DEERE & COMPANY, ONE JOHN DEERE PLACE, MOLINE, IL, 61265, US

(21) Appl. No.: 12/608,235

(22) Filed: Oct. 29, 2009

(30) Foreign Application Priority Data
Nov. 19, 2008 (DE) 10 2008 043 845.6

(51) Int. Cl. G06F 7/00

(52) U.S. Cl. 701/50

(57) ABSTRACT

A vehicle with a loader device is provided. The loader device comprises a loader boom, and a hydraulic system for raising and lowering the loader boom. A hydraulic suspension system for cushioning the loader boom, and a control unit for controlling the suspension system are provided. In order to optimize the comfort and the productivity when the hydraulic suspension system is activated, it is proposed that the control unit is designed in such a manner that the suspension system can be controlled as a function of a control variable representing a vehicle speed.

### FIELD OF THE INVENTION

The invention herein relates to a vehicle with a loader device, such as a tractor with a front end loader, wherein the loader comprises a loader boom, and furthermore has a hydraulic system for raising and lowering the loader boom, a hydraulic suspension system for cushioning the loader boom, and a control unit for controlling the suspension system.

### BACKGROUND OF THE INVENTION

Suspension systems for loaders on vehicles, in particular for front-end loaders on agricultural tractors, are known and are provided by many manufacturers as a feature which enhances the comfort of the operator and increases productivity. Suspension systems of this type are generally of a hydraulic design and are based upon an interaction between one or more hydraulic accumulators and the hydraulic cylinders actuating the loader. The suspension systems are further designed in such a manner that they can be switched on and off via a switching valve, wherein switching on and off generally takes place manually and is carried out individually by the vehicle operator depending on the application requirements. For this purpose, for example, the vehicle cab can be provided with an activating switch which is used to control a corresponding switching valve which, in turn, blocks or releases the hydraulic accumulator(s), the switching valves are customarily designed as electromagnetic switching valves. However, it is frequently disadvantageous, particularly during operation when stationary, that the suspension system is activated, since the response behavior of the loader is falsified when the suspension system is activated. The vehicle driver either has to accept these disadvantages or has to remember to deactivate or switch off the suspension system before carrying out the corresponding operations.

### SUMMARY OF THE INVENTION

It is therefore an object of the invention providing a vehicle and loader of the type mentioned at the beginning, by means of which the aforementioned problems are overcome.

According to the invention, a vehicle and loader of the type mentioned at the beginning has a control unit which is designed in such a manner that the suspension system of the loader can be controlled as a function of a control variable representing a vehicle speed. It is thus possible, for example, for the suspension system to be activated or deactivated automatically when the vehicle is stationary or when a predetermined threshold value for a vehicle speed is reached, without the vehicle driver having to operate a switch to control the suspension system. In this case, the variable representing the vehicle speed can be generated, for example, by a speed or rotational speed sensor and passed to the control unit. The variable representing the vehicle speed can further be derived from any variable physically connected to vehicle speed and passed on to the control unit. It is also possible to provide an electronic bus system, for example a CAN BUS system, which automatically delivers the required vehicle speed control variables to the control unit. The control unit then generates a corresponding control signal which is used for controlling a switching valve activating (or deactivating) the suspension system.

In a preferred embodiment of the invention, the control unit is designed in such a manner that the suspension system is switched on when a threshold value, which can be predetermined for the control unit, for the vehicle speed is exceeded. In this case, when a control variable representing the threshold value for the driving speed is reached, the control unit generates a control signal which switches on the suspension system or which controls the control valve activating the suspension system such that the suspension system for the loader is activated.

In another embodiment of the invention, the control unit is designed in such a manner that the suspension system is switched off when a threshold value, which can be predetermined for the control unit, for the vehicle speed is fallen short of. In this case, when a control variable representing the threshold value for the driving speed is reached, the control unit generates a control signal that either switches off the suspension system or controls the control valve activating the suspension system such that the suspension system for the loader is deactivated.

An input device is preferably provided on the vehicle, with which the threshold value for the vehicle speed can be predetermined for the control unit. Via the input device, the vehicle driver can input or set the threshold speed value at which the control unit is to trigger or generate the corresponding control signal in order to control the suspension system.

Preferably, by way of the input device, an operating mode for activating or deactivating the suspension system can be selected such that manual control of the suspension system is permitted via an activating switch for the suspension system.

In another embodiment of the invention, the suspension system comprises electronically controllable damping means by which damping of the suspension system can be varied, and the damping means can be controlled as a function of the control variable representing the vehicle speed. The damping means can be designed as an electronically adjustable throttle valve by which the cushioning rate or damping rate of the suspension system can be varied by, for example, the cross section of the line leading to a hydraulic accumulator of the suspension system being reduced or increased.

Preferably, one or more regulating values for the damping means can be input by the input device, said regulating values being used by the control unit as a function of the control variable representing the vehicle speed in order to control the damping means. Thus, different predetermined damping rates can also be adjusted as a function of the vehicle speed or controlled by the control unit such that, for example, the damping rate of the suspension system is increased as vehicle speeds increase. Depending on the application, however, the damping may also be reduced as vehicle speeds increase. In this case, the regulating values for the damping rates may preferably be input into the input device in the form of individual regulating values or else in the form of a damping curve as a function of the vehicle speed such that the damping can also be continuously and infinitely variably matched to the vehicle speed.

### BRIEF DESCRIPTION OF THE DRAWINGS

The invention is described and explained in more detail below with reference to the accompanying drawings wherein:

FIG. 1 is a schematic side view of a vehicle according to the invention in the form of a tractor with a loader; and,

FIG. 2 is a schematic circuit diagram of a hydraulic suspension system for the loader device of FIG. 1.

### DESCRIPTION OF THE PREFERRED EMBODIMENT

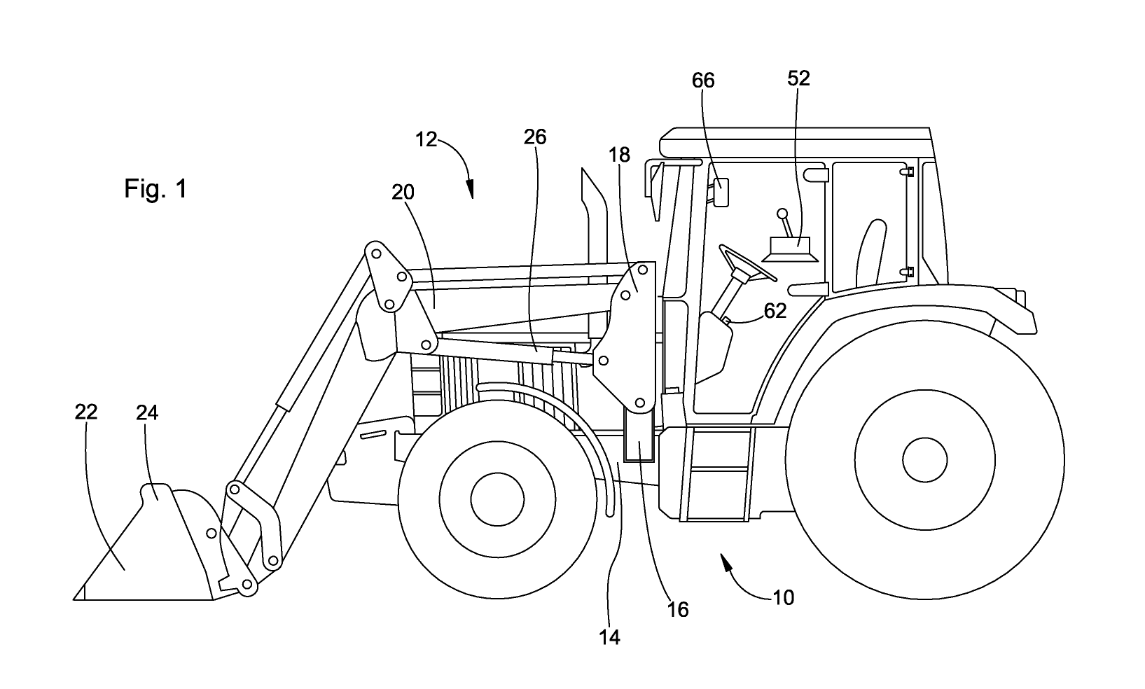

FIG. 1 shows a vehicle 10 in the form of an agricultural tractor which is equipped with a loader 12. The loader 12 is designed as a front-end loader. The vehicle 10 has a vehicle frame 14 to which a bracket 16 for the attachment of the loader 12 is fastened. Further, the vehicle 10 comprises a vehicle cab 17.

The loader 12 comprises a mast 18 with which the loader is connected to the bracket 16. Further, the loader 12 comprises a loader boom 20 which is equipped with an implement 22 in the form of a loading bucket 24. The implement 22 is designed as a loading bucket 24 here only by way of example. Other implements 22, for example a loading fork or a gripper, may, also be used.

A respective hydraulic cylinder 26 extends on both sides between the loader boom 20 and mast 18, the hydraulic cylinder being actuatable by means of a hydraulic system 28 in order to raise and lower the loader boom 20.

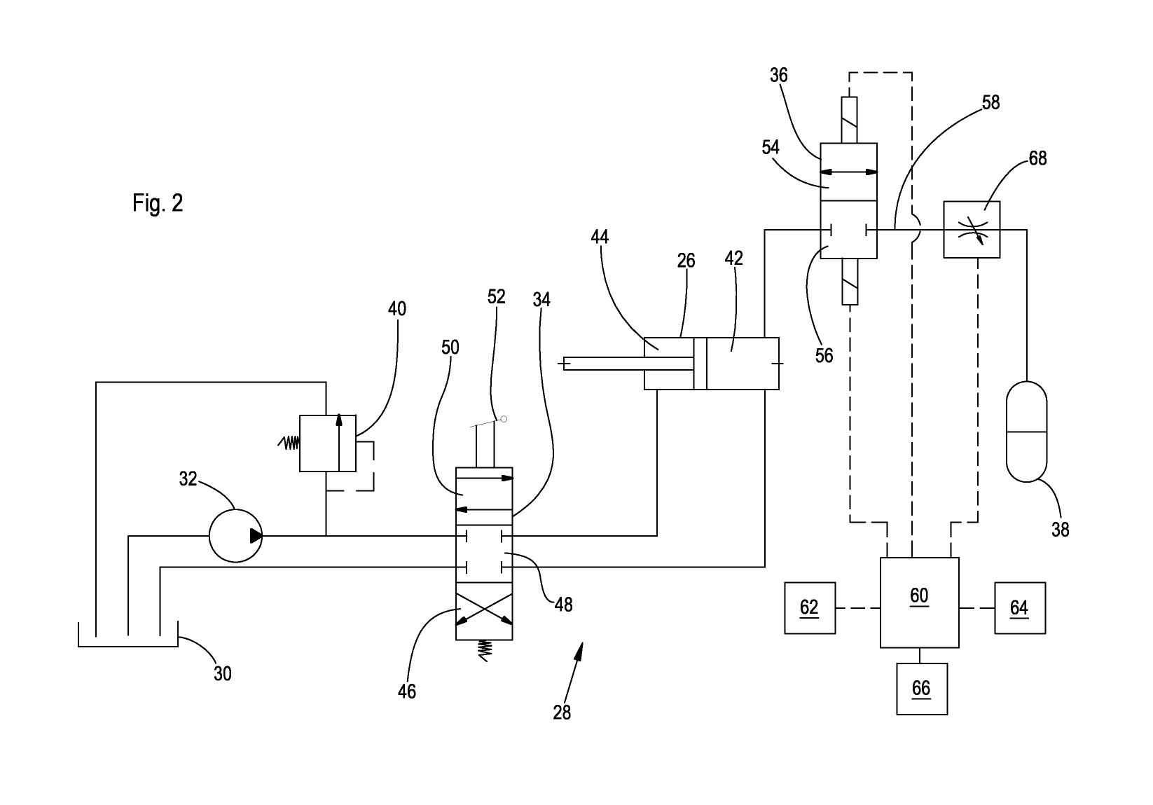

The hydraulic system 28 for raising and lowering the loader boom 20 is illustrated in FIG. 2 with reference to a schematic hydraulic circuit diagram.

The hydraulic system 28 comprises a hydraulic tank 30, a hydraulic pump 32, a main control valve 34, one or more hydraulic cylinders 26, a switching valve 36 and a hydraulic accumulator 38. A pressure-limiting device 40 is also provided.

The main control valve 34 is designed as a 4/3-way directional control valve with a central locking position and connects the hydraulic cylinder 26 to the hydraulic pump 32 and the hydraulic tank 30, the hydraulic cylinder 26 being designed as a double-action hydraulic cylinder 26 with a chamber 42 on the lifting side (piston side) and a chamber 44 on the lowering side (rod side). It is also possible in this case for the hydraulic cylinder to be designed such that it acts on one side, and therefore the chamber on the lowering side is omitted.

In a first switching position, the raising position 46, the raising function is triggered by the chamber 42 on the lifting side being connected to the hydraulic pump 32 and it being possible for the hydraulic oil to flow out of the chamber 44 on the lowering side into the hydraulic tank 30. The loader boom 20 can be raised in the raising position 46.

In a second switching position, the retaining position 48, the retaining function is triggered by the chambers 42, 44 on the lifting side and lowering side being separated from the hydraulic pump 32 and hydraulic tank 30 wherein it is not possible for hydraulic oil to flow from the hydraulic pump 32 to the hydraulic cylinder 26 or from the hydraulic cylinder 26 to the hydraulic tank 30. With the retaining position 48, the loader boom 20 can be retained in a corresponding pivoted position.

In a third switching position, the lowering position 50, lowering function is triggered by the chamber 42 on the lowering side being connected to the hydraulic pump 32 and it being possible for the hydraulic oil to flow out of the chamber 44 on the lifting side into the hydraulic tank 30. The loader boom 20 can be lowered in the lowering position 50.

The individual switching positions can be selected by the vehicle driver, for example, via a manual control lever 52 or joystick.

Further, the chamber 42 on the lifting side of the hydraulic cylinder 26 is connected to the switching valve 36 which is designed as an electronically controllable 2/2-way directional control valve. It has a pass-through position 54 and a closed position 56. The switching valve 36 connects the chamber 42 on the lifting side to the hydraulic accumulator 38 via a line 58, the chamber 42 on the lifting side being connected to the hydraulic accumulator 38 in the pass-through position 54 and being separated therefrom in the closed position 56. By means of corresponding control or switching of the switching valve 36, a hydraulic suspension system for the hydraulic cylinder 26 is therefore activated or deactivated by the chamber 42 on the lifting side being connected to the hydraulic accumulator 38 or being separated therefrom. In the activated state, i.e. in the pass-through position 54 of the switching valve 36, hydraulic oil can flow under load out of the chamber 42 on the lifting side into the hydraulic accumulator 38 and can flow out therefrom back again into the chamber 42 on the lifting side such that a cushioning function for the hydraulic cylinder 26 or for the loader boom 20 is produced.

The hydraulic system 28 further comprises an electronic control unit 60, an activating switch 62, a speed sensor 64 and an input device 66.

The electronic control unit 60 can be arranged both in the vehicle 10 and on the loader 12 itself. It can also be designed as part of an electronic control unit which is already present in any case on the vehicle 10, or can be implemented there.

The speed sensor can be designed as any sensor representing the speed of the vehicle 10, in particular as a rotation speed sensor which is arranged in the drive train or on the drive axles of the vehicle 10. It is also conceivable to tap off a speed signal from a CAN BUS system which is present and pass said signal to the control unit 60.

The electronic control unit 60 is connected to the activating switch 62 for activating the hydraulic suspension system, to a speed sensor 64 for detecting or recording the driving speed or for recording a variable representing the driving speed, and to the input device 66 for inputting regulating variables and threshold values and for selecting one or more operating modes.

The activating switch 62 and the input device 66 are preferably arranged in the vehicle cab 17 where they can be operated or actuated by a vehicle driver.

Actuation of the activating switch 62 can lead to the hydraulic suspension system of the hydraulic system being activated. The electronic control unit 60 then generates a corresponding control signal and switches the switching valve 36 into the pass-through position 54. Further, one or more threshold values, upon the reaching of which a control signal for controlling the switching valve is to be generated, are preset or stored in the control unit 60. When the hydraulic suspension system is activated and switched on (the switching valve 36 is in the pass-through position 54), the sensor signals or sensor signal variables supplied by the speed sensor 64 are compared with the threshold value stored in the control unit 60. If the driving speed decreases and reaches the preset threshold value, the control unit 60 generates a corresponding control signal which switches the switching valve 36 into its closed position 56 and therefore deactivates or switches off the hydraulic suspension system. If the vehicle then accelerates again and the driving speed increases again, when the preset threshold value is reached a corresponding control signal is in turn generated by the electronic control unit 60 and the switching valve 36 is switched again into its pass-through position 54 and therefore the hydraulic suspension system is activated or switched on again.

The abovementioned threshold values can be selected freely here by the vehicle driver and input via the input device 66 and stored in the control unit 60. Additionally, a corresponding operating mode can be selected in the input device 66, said operating mode permitting the electronic control unit 60 to be operated without automatic control that is dependent on the driving speed. If this mode is activated, the suspension system can be activated or deactivated manually via the activating switch 62 irrespective of the driving speed or irrespective of a driving speed signal.

In an expanded exemplary embodiment, a throttle device in the form of a throttle valve 68 is provided. The throttle valve 68 is arranged in the line 58 between the switching valve 36 and the hydraulic accumulator 38 and is controlled via the electronic control unit 60 likewise in accordance with predetermined desired values or regulating variables. Depending on the control signal, which can be generated by the control unit 60 as a function of the driving speed, a pass-through cross section of the throttle valve 68 and therefore the damping of the hydraulic suspension system can be varied electronically as a function of the driving speed.

For example, the throttle cross section of the throttle valve 68 can be reduced as the driving speed increases, thus producing harder cushioning (greater damping of the suspension system). Similarly, the throttle cross section can also be increased automatically as the driving speed decreases, thus producing softer cushioning (lower damping of the suspension system). The regulating values or regulating variables required for this can be input by the vehicle driver in the input device 66 and stored. A damping function can be selected or deselected via the operating modes. Damping curves as a function of vehicle speed can also be stored, the damping curves making it possible to select different damping characteristics for different operating states.

Having described the preferred embodiment, it will become apparent that various modifications can be made without departing from the scope of the invention as defined in the accompanying claims.

The invention claimed is:

1. A vehicle with a loader device, wherein the loader device comprises a loader boom, and a hydraulic system for raising and lowering the loader boom, a hydraulic suspension system for cushioning the loader boom, and a control unit for controlling the suspension system, wherein the control unit is designed in such a manner that the suspension system is controlled as a function of a control variable representing a vehicle speed.

2. A vehicle according to claim 1, wherein the suspension system is switched on when a predetermined threshold value for the vehicle speed is one of: exceeded or fallen short of.

4. A vehicle according to claim 2, wherein an input device is provided with which the threshold value for the vehicle speed can be predetermined for the control unit.

5. A vehicle according to claim 2, wherein an input device is provided with which at least one operating mode can be selected for the suspension system, said operating mode permitting manual control of the suspension system via an activating switch for the suspension system.

6. A vehicle according to claim 1, wherein the hydraulic system comprises electronically controllable damping means for the hydraulic suspension system, by means of which damping of the suspension system is varied, and the damping means is controlled as a function of a control variable representing the vehicle speed.

7. A vehicle according to claim 6, wherein regulating values for the damping means can be one of: input or predetermined by the input device, said regulating values being used by the control unit as a function of the control variable representing the vehicle speed in order to control the damping means.
